(19) United States
(12) Patent Application Publication
(10) Pub. No.: US 2006/0273109 A1
(43) Pub. Date: Dec. 7, 2006

(54) Device and method for transferring, mixing and delivering components

(75) Inventor: Wilhelm A. Keller, Merlischachen (CH)

Correspondence Address: FOLEY AND LARDNER LLP;SUITE 500, 3000 K STREET NW, WASHINGTON, DC, 20007, US

(73) Assignee: Mixpac Systems AG

(21) Appl. No.: 10/568,539

(22) PCT Filed: Aug. 18, 2004
(86) PCT No.: PCT/CH04/00518

§ 371 Date: Feb. 17, 2006

(30) Foreign Application Priority Data
Aug. 21, 2003 (CH) 1424/03

(51) Int. Cl. B67D 5/60

(52) U.S. Cl. 222/145.5

(57) ABSTRACT

The arrangement for transferring, mixing, and dispensing preferably comprises at least two dispensing devices (1, 2). One of said dispensing devices (2) comprises liquid components (21, 23) and the arrangement comprises a transfer unit (15) for the connection of said dispensing devices (1, 2), and said transfer unit comprises connecting channels (36, 38) between outlets (17, 18; 41, 42) for the components (21, 23; 22, 24) in the storage containers (5, 6; 7, 8) of said dispensing devices (1, 2). For an increased reliability of operation, said transfer unit (15, 31, 39) comprises locking members (36) for receiving corresponding flanges (19, 20) provided on said dispensing devices (1, 2). A syringe system of this kind, using double syringes, allows an unproblematic storage and an easy and thorough mixing of multiple components as well as a simple dispensing of the mixtures. An arrangement of this kind offers particular advantages when the first syringe contains a powder or granulate, e.g. bone cement or a bone replacement material.

The present invention relates to an arrangement and method for transferring, mixing, and dispensing components that comprises at least two dispensing devices, according to the preamble of claims 1 and 10.

An arrangement of this kind is known from EP-0 292 472, disclosing a set for preparing and applying a tissue adhesive where in each case four syringe bodies are combined in pairs via a coupling member to form a respective unit. The coupling member comprises respective cones for receiving a corresponding conical portion on the syringe, but such a cone connection is insufficient for higher pressures and in applications having high safety requirements. Moreover, the reference only discloses connections between two opposite or adjacent syringes, respectively.

In certain applications it is necessary to mix and dispense up to four or even more components, and the components may be both liquid and powdery, granular, or porous. Generally, the components are stored separately and mixed by shaking, stirring, and/or by means of a static mixer, or dissolved.

On this background, it is the object of the present invention to provide an arrangement and a method as defined above that allow not only a simple handling and a thorough mixing but also a high reliability of operation. An arrangement and a method attaining this object are described in claims 1 and 10.

The invention will be explained in more detail hereinafter with reference to drawings of exemplary embodiments.

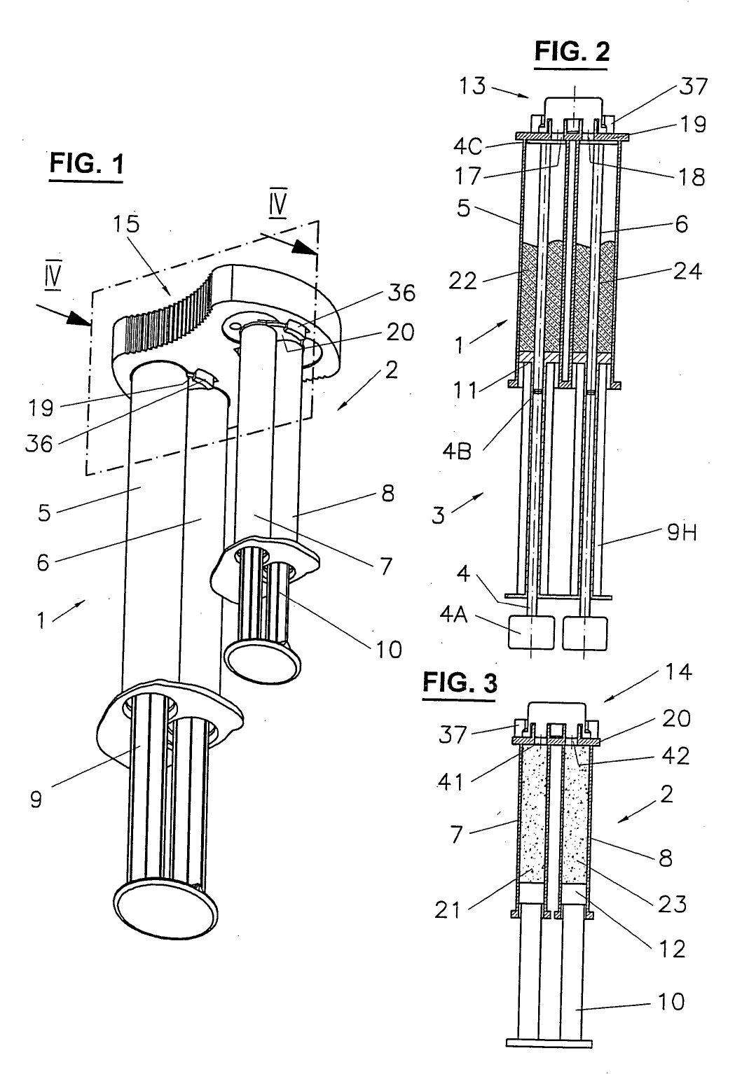

FIG. 1 shows a perspective view of a first exemplary embodiment of an arrangement of the invention having syringes that are arranged in parallel;

FIG. 2 shows a front view and partial section of the first double dispensing device of FIG. 1 with additional mixing arrangements;

FIG. 3 shows a lateral view and partial section of the other double dispensing device of FIG. 1;

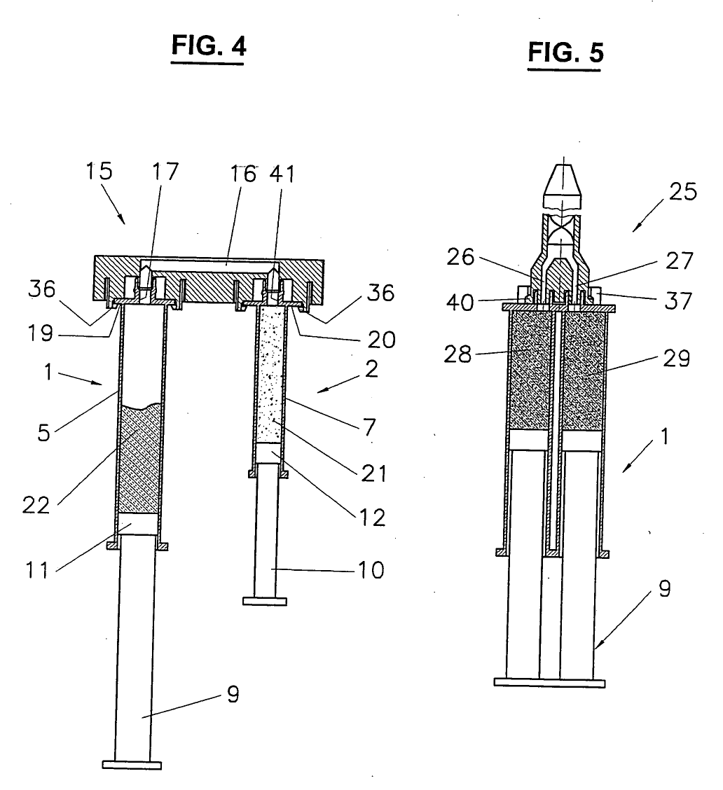

FIG. 4 shows a section according to line IV-IV in FIG. 1;

FIG. 5 shows a front view and partial section of the first double dispensing device of FIG. 1 with the mixer attached;

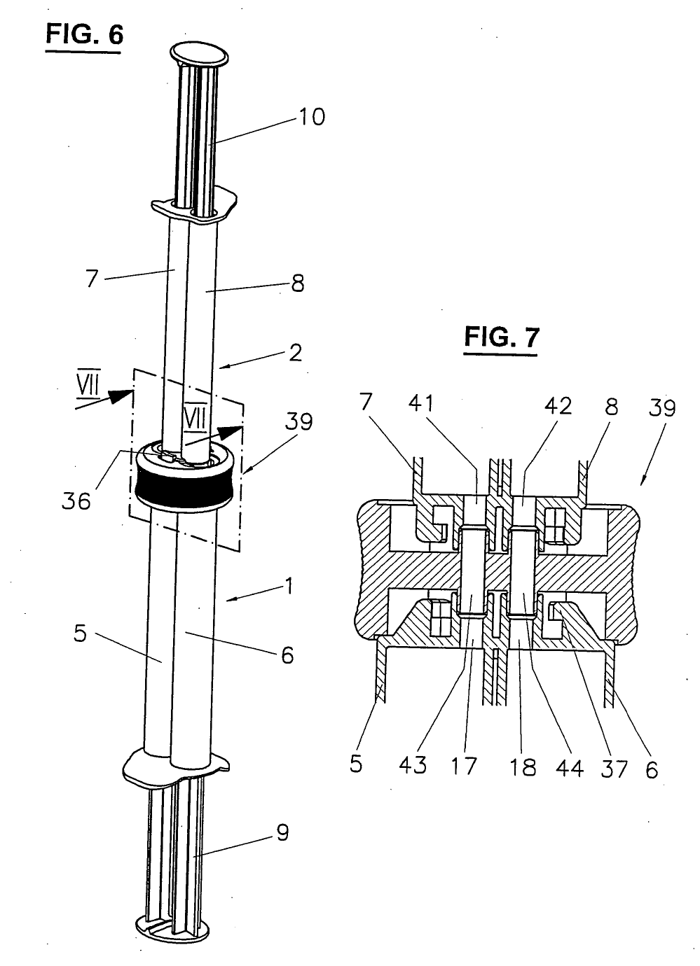

FIG. 6 shows an embodiment variant having two double syringes that are connected to each other frontally;

FIG. 7 shows a section according to line VII-VII in FIG. 6;

FIG. 8 shows a variant of the first example according to FIG. 1, and

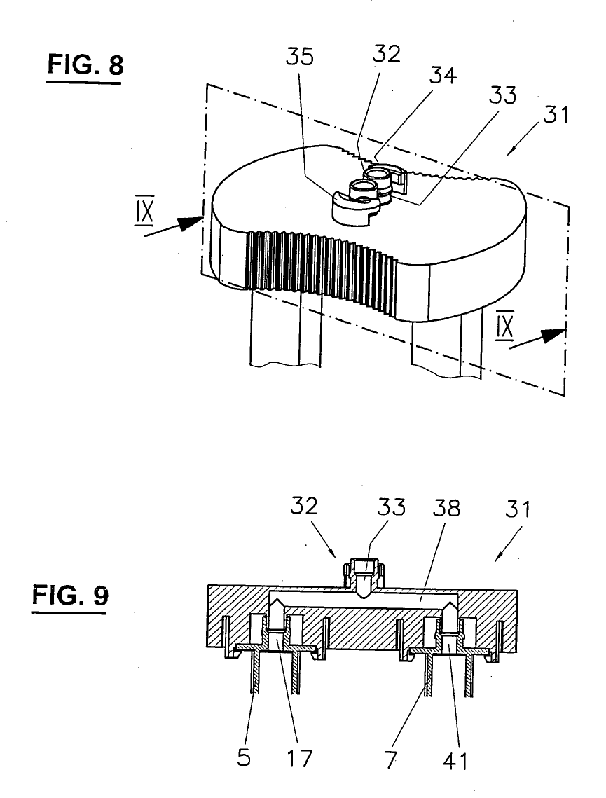

FIG. 9 shows a section according to line IX-IX in FIG. 8.

The first exemplary embodiment of an arrangement of the invention comprises a first and a second double dispensing device, hereinafter designated as double syringe 1 and double syringe 2, each having two storage containers 5 and 6 resp. 7 and 8. The double syringes comprise respective double thrust rods 9 and 10 with pistons 11 and 12 arranged thereon, see FIGS. 2 to 5, and are closed with closure caps 13 and 14, see FIGS. 2 and 3.

The described double syringes are available on the market. The essential aspect of the arrangement of the invention is the transfer of the content of one double syringe into the content of the other double syringe and the subsequent dispensing through a mixer or an accessory such as a tip or the like, or the transfer of the components of the double syringes to a common coupling for a mixer or an accessory. The connection between the two double syringes is ensured by the transfer unit which, depending on the embodiment, provides the above described transfer modes.

Alternatively, instead of double syringes, conventional double cartridges may be used whose pistons are actuated by the thrust rods of a dispensing appliance. Furthermore, all examples of double dispensing devices analogously apply to single or multiple dispensing devices.

In the first embodiment variant, transfer unit 15 comprises two transfer channels of which only anterior transfer channel 16 is visible in FIG. 4 which provides the connection between the two anterior outlets 17 and 41 of storage containers 5 and 7 of double syringes 1 and 2.

As appears in FIGS. 1 and 4, the syringes are connected to the transfer unit by respective detachable locking mechanisms, locking members 36 of the transfer unit enclosing flanges 19 and 20, respectively, of syringes 1 and 2.

In FIGS. 2 and 3, the two double syringes 1 and 2 are illustrated in the filled condition as in FIG. 1, both syringes being provided with respective closure caps 13 and 14.

In the embodiment variant according to FIGS. 1 to 5, attaching the two double syringes to the transfer unit establishes a connection between the outlets of the double syringes. Thus, the liquids from storage containers 7 and 8 of double syringe 2 may e.g. enter into the storage containers 5 and 6 of double syringe 1 for being mixed with the components contained therein. More specifically, liquid component 21 from storage container 7 is delivered to component 22 in storage container 5, which may be a powder, and liquid component 23 from storage container 8 to component 24 in storage container 6, which may also be a powder or a granulate.

After the transfer by means of double thrust rod 10, the components are mixed by shaking or stirring or are dissolved, and double syringe 2 may be removed and disposed of. Transfer unit 15 may be removed as well, and syringe 1 filled with mixtures 28 and 29 may be provided via bayonet coupling 37 with a mixer 25, see FIG. 5, or with another accessory.

According to FIG. 2, containers 5 and 6 of double syringe 1 from which the mixture is dispensed each comprise a mixing arrangement 3 including a mixing rod 4 provided with a turning knob 4A, a rupture point 4B for breaking it off after the mixing operation, and a mixing disk 4C that may e.g. be perforated and/or provided with peripheral cutouts or designed in another manner. More specifically, the thrust rods are designed as hollow thrust rods 9H in which the mixing rods are guided. In the mixing operation, the rod is moved back and forth as well as rotated. On one hand, not every container necessarily comprises a mixing arrangement, and on the other hand, the containers may be equipped with different mixing arrangements. Moreover, in the present context, the term “mixing” also comprises the dissolution of one component in another.

The two mixtures 28 and 29 resulting from mixing component 21 with component 22 and component 23 with component 24, respectively, are driven through mixer 25 by means of double thrust rod 9, mixer 25 having inlets 26 and 27 as well as mixing elements 30.

In the exemplary embodiment of FIGS. 6 and 7, double syringes 1 and 2 are not arranged in transfer unit 39 in parallel to each other but frontally opposite each other. Here also, locking members 36 of transfer unit 39 enclose flanges 19 resp. 20 of the syringes. The section of FIG. 7 illustrates the two outlets 17 and 18 of syringe 1 as well as bayonet coupling members 37 serving for the connection of a mixer or accessory. Analogously, the same applies to outlets 41, 42 and bayonet coupling members 37 of syringe 2. The two outlets 17 and 18 are connected to outlets 41 and 42 by two connecting channels 43 and 44.

The function is similar to that of the first exemplary embodiment, i.e. first the two syringes are attached to the transfer unit, the liquid from double syringe 2 is transferred to double syringe 1 and then syringe 2 and the transfer unit are removed from syringe 1 and after the mixing operation by shaking or by means of a mixing arrangement 3, a mixer or an accessory can be attached to syringe 1, whereupon the mixtures are dispensed from syringe 1. Here also, it would be possible theoretically to provide a transfer unit for more than two double syringes.

FIGS. 8 and 9 illustrate an embodiment variant where, instead of first transferring the components from one double syringe to the other one and then to the mixer, all four components are merged in respective pairs and reach a common coupling. Transfer unit 31 comprises a coupling 32 having two outlets 33 and 34 as well as bayonet sockets 35 serving for the attachment of a mixer or of other accessories.

Outlets 17 and 41 as well as coupling flanges 19 and 20 of the syringes are same as in the variant according to FIG. 1, and the same locking members 36 as illustrated in FIG. 1 are provided on the syringe side of the transfer unit. Of the connecting channels, only one is visible, namely channel 38 in FIG. 9, which interconnects the two outlets 17 and 41 and leads to outlet 33, whereas the other, non-represented connecting channel leads to outlet 34. For certain applications it is conceivable that the two connecting channels lead to a common outlet rather than to respective outlets 33 and 34.

Based on the exemplary embodiments described above, it is possible to interconnect more than two double syringes using an adapted transfer unit whereby another liquid containing e.g. hormones, antibiotics or the like may be admixed to the mixture while it is being dispensed or a second double syringe or single syringe may be connected to double syringe 1 that is ultimately used for dispensing.

For dispensing, instead of the static mixer, an outlet attachment of any kind may be attached. Mixing of mixtures 28 and 29 may be achieved by shaking double syringe 1 or by means of mixing arrangement 4.

The size of the storage containers of the double syringes may differ both in length and diameter. The double syringes need not be arranged in parallel, as illustrated. Also, the double syringe that is dispensing may be inserted in a dispensing appliance as it is usual practice with double cartridges. The components in the dispensing double syringe may be powdery or liquid. Furthermore, outlets 33 and 34 need not be of the same kind and may have different diameters. Analogously, what has been disclosed for double syringes is also applicable to double cartridges, to single syringes or cartridges, or to other interconnected dispensing devices.

1. Arrangement for transferring, mixing, and dispensing components that comprises at least two dispensing devices, at least one of the dispensing devices containing at least one liquid component and the arrangement comprising a transfer unit for the connection of the dispensing devices that at least comprises connecting channels between two adjacent or opposite dispensing devices, wherein the transfer unit comprises connecting channels between outlets for the components of both dispensing devices and locking members for receiving corresponding locking members on flanges provided on the dispensing devices.

2. Arrangement according to claim 1, wherein the connecting channels of the removably attachable transfer unit are configured for transferring the liquid components from one of the dispensing devices to another dispensing device that is arranged in parallel thereto.

3. Arrangement according to claim 2, wherein the transfer unit comprises connecting channels between one outlets respectively of one storage containers of the one or the other dispensing device.

4. Arrangement according to claim 1, wherein the transfer unit is adapted for receiving at least two frontally opposite dispensing devices, the transfer unit having pairs of through-going connecting channels between the outlets of the dispensing devices.

5. Arrangement according to claim 1, wherein the transfer unit comprises connecting channels from the outlets of the dispensing devices to a common coupling having at least one outlet for a mixer or an accessory.

6. Arrangement according to claim 1, wherein at least one of the storage containers comprises a mixing arrangement.

7. Arrangement according to claim 1, wherein the dispensing devices are double dispensing devices.

8. Arrangement according to claim 7, wherein the dispensing devices are double syringes with double thrust rods.

9. Arrangement according to claim 7, wherein the dispensing devices are double cartridges with dispensing pistons.

10. A method for transferring, mixing, and dispensing components by means of an arrangement of claim 1, wherein the dispensing devices are coupled to the transfer unit, the dispensing device for the liquid component is actuated for introducing that component into the other one, and the two components are mixed in another dispensing device and the mixture is dispensed.

11. The method of claim 10, wherein the dispensing devices are double dispensing devices.
